(19) United States
(12) Patent Application Publication
(10) Pub. No.: US 2026/0061497 A1
(43) Pub. Date: Mar. 5, 2026

(54) CUTTING TOOL AND RELATED METHODS

(71) Applicant: Kennametal Inc., Latrobe, PA (US)

(72) Inventors: Michael Orange, Latrobe, PA (US); John Brosnahan, Latrobe, PA (US)

(73) Assignee: Kennametal Inc., Latrobe, PA (US)

(21) Appl. No.: 18/816,353

(22) Filed: Aug. 27, 2024

(51) Int. Cl. B23B 27/10

(52) U.S. Cl. CPC B23B 27/10

(57) ABSTRACT

A cutting tool includes a body have a first end and a second end opposite the first end. The first end can have one or more cutting elements positioned thereon adjacent to one or more fluid apertures (e.g. holes) positioned to facilitate injection of fluid out of the body and adjacent to the cutting elements. The second end can have a chamber defined therein that is in fluid communication with the one or more apertures via one or more conduits defined to extend from the chamber to the one or more apertures. In some embodiments, the first end can have flutes defined therein and cutting elements can be positioned on edges of the flutes. In some embodiments, the body of the cutting tool can be made via an additive layer manufacturing process to form the body having the aperture(s), conduit(s), and chamber.

### FIELD OF THE INVENTION

The present invention relates to a cutting tool and methods for making and using a cutting tool.

### BACKGROUND OF THE INVENTION

Examples of cutting tool assemblies can be found in U.S. Pat. Nos. 8,123,442, 8,637,127, 8,734,068, 8,807,888, 9,168,601, and 10,195,678 and U.S. Patent Application Publication Nos. 2024109131, 2021/053128, 2020/0254545 and 2020/0246889. Cutting tools can be used in metalworking, for example. Some cutting tools can be stationary. Other types of cutting tools can be moveable (e.g. rotatable, etc.). The cutting tool can be utilized to manipulate a workpiece to form a device, a part, or a component part, for example.

### SUMMARY OF THE INVENTION

We determined that tools that utilize cooling channels to help cool the tools during use can be limited in geometry due to manufacturing technology of drilling holes that may be formed in the tools. This can be particularly true for rounded tools that may rely upon the use of green machine drilling or electrical discharge machining (EDM) to form holes or cooling channels in a tool. The holes that are typically formed in such tools are often utilized to facilitate a flow of fluid that can help cool the tool while it is in use to avoid the tool from overheating.

The fluid that is utilized can also help remove chips from a workpiece that may become positioned on the tool during use so that the tool can be cleaned during use. The flow of the fluid and how it may be routed through the tool can be limited due to the geometrical design constraints of the tool and how those constraints can limit the ability of drilling or EDM to form discharge openings for the fluid.

We have developed a cutting tool that can provide a higher performance coolant delivery that can also better assist in chip evacuation. Embodiments can provide improved coolant conduit flow path configurations that can provide higher performance coolant delivery to a tool, which can increase the productivity of the tool and significantly improve the life of the tool. Embodiments can be configured so that the coolant flow velocity and volume can be improved significantly. For instance, some embodiments can provide a significant increase in coolant channel size, avoid or minimize utilization of sharp corners and/or sharp angular turns that can reduce coolant flow resistance so a higher velocity flow of coolant can be emitted from the tool to help with cleaning and also permit a higher rate of cooling to be provided by the coolant. The body of the cutting tool can be defined so that a direction of the coolant flow can be defined to better control fluid ejection from the cutting tool body to more effectively remove chips from cutting as well. Moreover, embodiments can be provided that provide a lower weight tool that can use less material for fabrication of the tool.

We have surprisingly found that embodiments that utilize this type of lightweight tool design can allow embodiments to be less costly to manufacture while still providing a tool that has sufficient strength, stiffness, and toughness for industrial use while also having substantially better coolant flow and chip removal features. Embodiments can permit a cutting tool to be utilized to have a longer life and provide improved manufacturing flexibility (e.g. by requiring less downtime and/or maintenance) in addition to having a lower capital cost that is more environmentally friendly (e.g. via use of less metal to form the tool, etc.).

A cutting tool can include a body comprised of carbide, tungsten carbide, cemented carbine, cemented tungsten carbide, tool steel, steel, or other suitable type of metal. The cutting tool can also include one or more cutting elements that can be attached to the body of the cutting tool so that each cutting element is integral with the body (e.g. brazed to the body, etc.). The cutting elements can be comprised of polycrystalline diamond (PCD), tungsten carbide, carbide material, or other suitable material. The body of the cutting tool can include a first end that has the one or more cutting elements positioned thereon. A second end of the body that is opposite the first end can include a chamber to receive a coolant fluid. The body can be formed to define at least one conduit that extends from the chamber to one or more holes positioned adjacent to the one or more cutting elements to guide a flow of the coolant fluid from the chamber to the one or more holes for passing of the coolant fluid through the body and out the one or more holes.

The one or more holes can be defined to direct the fluid onto the outer surface of the body of the cutting tool to remove chips that may become positioned on the tool during use of the tool.

The conduit(s) can be defined so that the conduit(s) do not have sharp corners or sharp angular turns. In some embodiments, the conduit(s) can be defined to provide a smooth passageway for the fluid passed from the chamber to the one or more holes, for example. We have found such a feature to help reduce resistance to the flow of coolant to provide improved flow of coolant fluid that can allow fluid to be ejected out of the one or more holes at a greater flow velocity.

In some embodiments, the first end of the cutting tool body can be shaped to have multiple flutes. Each cutting edge of the flute can have a cutting element positioned thereon (e.g. attached thereon via brazing, etc.). The cutting element can be comprised of a material that is harder than the material of the body. For example, the body of the cutting tool can be formed from cemented carbide, carbide, or steel and each cutting element can be comprised of PCD.

In a first aspect, a cutting tool is provided. The cutting tool can include a body having an outer surface, a first end and a second end that is opposite the first end. A portion of the outer surface adjacent to the first end can have one or more recesses defined therein to receive one or more cutting elements. At least one hole can be defined in the outer surface adjacent the one or more recesses. The second end of the body can have a chamber defined therein to receive a coolant fluid. The second end can also have a mouth in fluid communication with the chamber. The body can have at least one conduit defined therein to fluidly connect the chamber to the at least one hole so that coolant fluid fed into the chamber is passable to the at least one hole for being emitted onto the outer surface via the at least one hole.

In some embodiments, the at least one hole can include a plurality of spaced apart holes.

In a second aspect, the body of the cutting tool can include a plurality of ribs positioned in the chamber to divide the chamber into sectors. In some embodiments, each of the ribs can have the same shape and size. In other embodiments, the ribs can have different shapes or sizes to define different sized or shaped sectors. In yet other embodiments, there can be multiple different sets of ribs in which each set of ribs may have different sizes or shapes.

In a third aspect, the at least one conduit can be defined so that the at least one conduit extends from the chamber to the at least one hole without any sharp edges or any sharp turns. A sharp turn can be an angular turn of the conduit that is greater than 60°. Such a sharp turn can be provided by drilling and embodiments can define the at least one conduit such that drilling may not be needed or is not needed.

In a fourth aspect, the body of the cutting tool can be formed via an additive manufacturing process to define the mouth, the chamber, the at least one conduit, and the at least one hole. In some embodiments, the additive manufacturing process is a binder jet process. Other embodiments may use another type of additive manufacturing process.

In a fifth aspect, the body of the cutting tool can be comprised of cemented carbide, cemented tungsten carbide, carbide material, or steel. Other embodiments may utilize other materials.

In a sixth aspect, the cutting tool can include one or more cutting elements. In some embodiments, the one or more cutting elements can be attached to the body via one or more recesses such that each cutting element is integral with the body. Each of the cutting elements can be comprised of a material that is harder than a material of the body. In some embodiments, the cutting elements can be comprised of PCD, cubic boron nitride material, a ceramic material, or other suitable material.

In a seventh aspect, the chamber can extend from the second end to an intermediate portion of the body between the first end and the second end. The chamber can have an interface with the at least one conduit that is opposite the mouth of the body. The chamber can be defined in the body such that at least 20% of a volume of the body between the interface and the mouth is empty space for receipt of the coolant fluid.

In an eighth aspect, the cutting tool can include a hub positioned within the chamber and a plurality of ribs that extend from the hub to an inner wall of the body defining the chamber to define different sectors of the chamber. The sectors can have the same shape or be sized differently.

In a ninth aspect, the cutting tool of the first aspect can include one or more features of the second aspect, third aspect, fourth aspect, fifth aspect, sixth aspect, seventh aspect, and/or eighth aspect. It should therefore be appreciated that other embodiments can include other features. Examples of additional features can be appreciated from the exemplary embodiments of a cutting tool discussed herein.

In a tenth aspect, a process of making and/or using a cutting tool is provided. The process can include forming a body of a cutting tool such that the body includes an outer surface, a first end and a second end. The body can be formed so that a portion of the outer surface adjacent the first end has one or more recesses defined therein to receive one or more cutting elements and also has at least one hole defined in the outer surface adjacent the one or more recesses. The body can be formed so that the second end has a chamber defined therein to receive a coolant fluid and so that the second end also has a mouth in fluid communication with the chamber. The body can be formed such that the body has at least one conduit defined therein to fluidly connect the chamber to the at least one hole so that coolant fluid fed into the chamber is passable to the at least one hole for being emitted onto the outer surface via the at least one hole. The process can also include attaching one or more cutting elements to outer surface of the body via the one or more recesses such that each cutting element is integral to the body.

In some embodiments, the cutting elements can be attached via brazing or other suitable attachment mechanism. For example, the one or more cutting elements can be attached to the body via brazing and the one or more recesses can be defined in at least one cutting edge of the body. The cutting element(s) can be positioned within the recess(es) and be integral to the body after being attached.

The body can be formed via an additive manufacturing process in some embodiments of the process. For example, the body can be formed via a binder jet process or other suitable additive manufacturing process.

In an eleventh aspect, the process can be performed such that the material of the body is a pre-selected type of material. For example, the body can be comprised of cemented carbide, cemented tungsten carbide, carbide material, or steel. The formation of the body can be provided via use of a powder or particulate of such material being utilized in an additive manufacturing process, for example.

In a twelfth aspect, the process can be performed so that the body is formed such that the chamber extends from the second end to an intermediate portion of the body between the first end and the second end. The chamber can be formed to have an interface with the at least one conduit that is opposite the mouth of the body. The chamber can be defined in the body such that at least 20% of a volume of the body between the interface and the mouth is empty space for receipt of the coolant fluid.

In a thirteenth aspect, the body can be formed such that the at least one conduit extends from the chamber to the at least one hole without having an angular turn that is greater than 60°. The one or more conduits can also be defined so that there are no sharp edges for a fluid flow path defined by the at least one conduit.

In a fourteenth aspect, the process of the tenth aspect can include one or more features of the eleventh aspect, twelfth aspect, and/or thirteenth aspect. Embodiments of the process can be performed to form an exemplary embodiment of the cutting tool, for example. Embodiments of the process can also include other steps such as passing fluid through the chamber and at least one conduit for use of the cutting tool to help cool the tool and remove debris away from the tool. It should therefore be appreciated that other embodiments of the process can include other steps or other features. Examples of such additional steps and/or features can be appreciated from the discussion of exemplary embodiments discussed herein.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting tool and methods of making and using the same are shown in the accompanying drawings. It should be appreciated that like reference numbers used in the drawings may identify like components.:

FIG. 1 is a perspective view of a first exemplary embodiment of the cutting tool with the cutting elements 6 removed to better illustrate recesses 3r.

FIG. 2 is another perspective view of the first exemplary embodiment of the cutting tool with the cutting elements 6 removed to better illustrate recesses 3r.

FIG. 3 is an end view illustrating the second end 3d of the first exemplary embodiment of the cutting tool.

FIG. 4 is a cross-sectional view of the first exemplary embodiment of the cutting tool taken along line G-G shown in FIG. 3.

FIG. 5 is a cross-sectional view of the first exemplary embodiment of the cutting tool taken along line K-K shown in FIG. 3.

FIG. 6 is a cross-sectional view of the first exemplary embodiment of the cutting tool taken along line L-L shown in FIG. 3.

FIG. 7 is a perspective view of a first exemplary embodiment of the cutting tool having the cutting elements 6 positioned in recesses 3r.

FIG. 8 is a flow chart illustrating a first exemplary embodiment of a process for making and/or using an embodiment of the cutting tool.

### DESCRIPTION

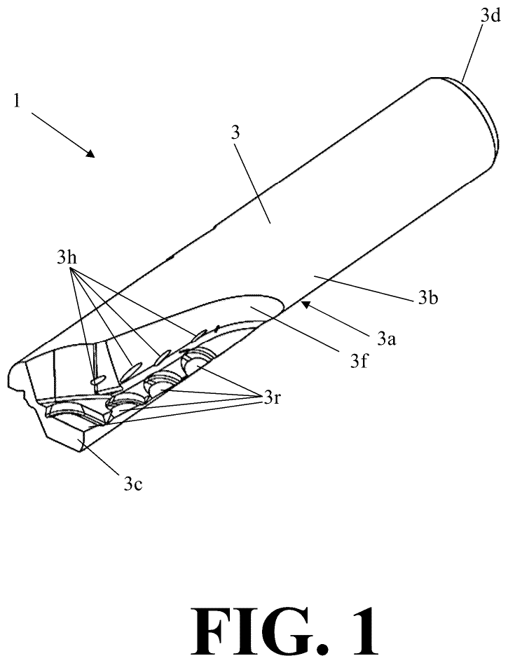

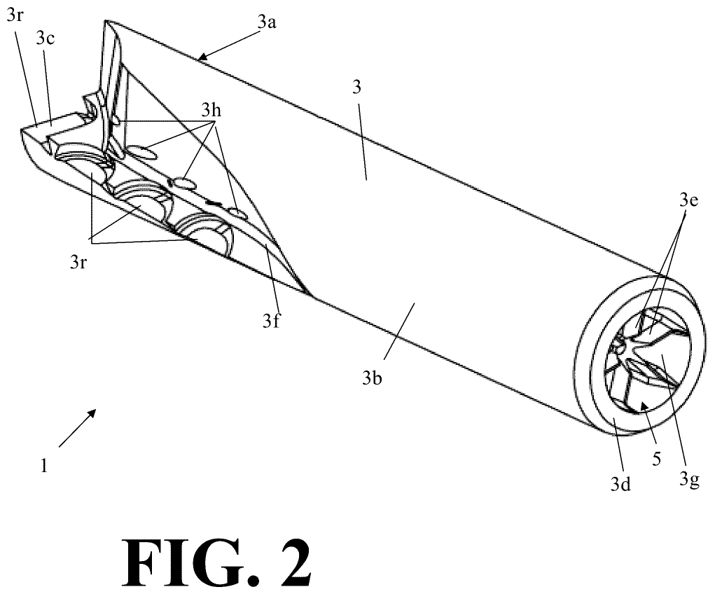

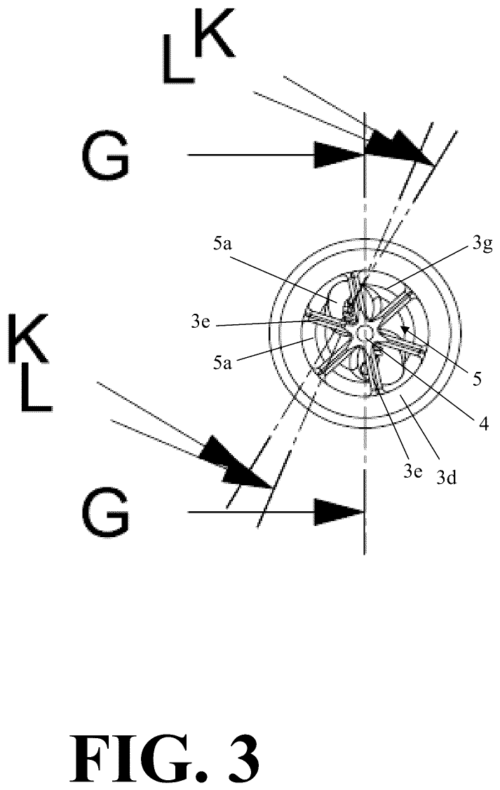

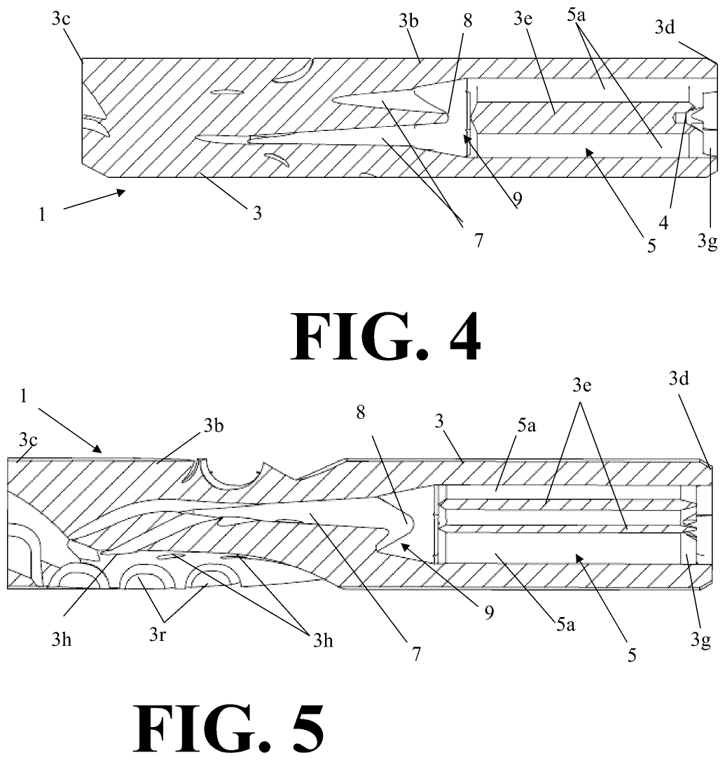

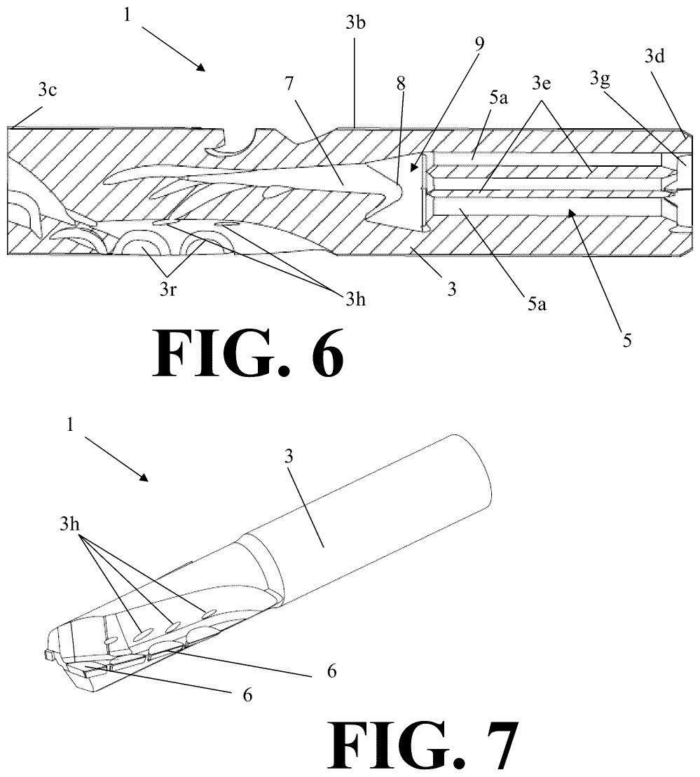

Referring to FIG. 1 through FIG. 7, a cutting tool 1 can include a body 3. The body can be comprised of metal or other suitable material. For example, the body 3 can be composed of steel, tool steel, cemented carbide, cemented tungsten carbide, a carbide material, or other suitable material. The body 3 can be formed to include a coolant fluid passageway system 9 within the body 3 and to have an outer surface 3a that is shaped so that a first end 3c of the body has one or more recesses 3r to retain one or more cutting elements 6 thereon or therein and has one or more holes 3h in fluid communication with the coolant fluid passageway system 9 for ejection of coolant fluid out of the body 3 and onto the outer surface 3a for removal of debris (e.g. cutting chips) and to facilitate cooling during use of the cutting tool 1. The recesses 3r and at least some of the holes 3h can be positioned in or on one or more flutes 3f defined in the body adjacent to the first end 3c and/or at the first end 3c of the body 3.

The body 3 can also have a second end 3d that is opposite the first end 3c. In some embodiments, the second end 3d can be a tapered end that narrows in width as it extends from an intermediate portion 3b of the body to the distal side of the second end 3d. In other embodiments, the second end 3d can have a reverse taper in which the width or diameter of the second end 3d is larger at its distal edge as compared to a more inward portion of the second end 3d that can be positioned closer to the intermediate portion 3b of the second end as compared to its distal edge.

The intermediate portion 3b of the body 3 can be positioned between the first and second ends 3c, 3d of the body 3. The body can be elongated in some embodiments such that the body has a length and a diameter or width that is less than its length. The body 3 can be cylindrical or tubular in shape in some embodiments such that the cross-sectional shape of the body 3 can be circular or oval in shape. In other embodiments, the body can have a polygonal shaped cross-section instead of an oval or circular cross-section.

The second end 3d of the body 3 can be defined to include a chamber 5 that is in fluid communication with a mouth 3g defined at a distal side of the second end 3d. The chamber 5 can be entirely within the second end 3d or can extend from the second end 3d to a position within the intermediate portion 3b of the body 3. The body 3 can have an inner wall defined therein to define the shape of the chamber 5 in the body.

The body 3 can be formed to have one or more ribs 3e within the chamber 5 at and/or adjacent to the second end 3d of the body to help provide structural support, stiffness, and strength to the body while also providing a large space that can define the chamber 5 of the body. In some embodiments, each rib 3e can extend between opposite sides of the chamber 5. In other embodiments, each rib 3e can extend from a central element defined within the chamber to a side of the chamber 5 such that the rib 3e extends like a spoke from a central hub 4 defined within a central region of the chamber 5. The ribs 3e can be formed so that they are all of uniform size and thickness. Alternatively, some ribs 3e can have a different thickness than other ribs to provide different sized ribs 3e within the chamber 5.

The ribs 3e can be defined in the chamber 5 to extend to the inner wall or extend between different sides of the inner wall that defines the chamber 5 (e.g. the ribs 3e can extend to opposite sides of the chamber 5). The ribs 3e can be positioned to define different sectors 5a of the chamber 5. The different sectors 5a can be separated from each other via the ribs 3e and/or central hub 4 positioned in the chamber 5. The different sectors 5a can extend from the mouth 3g to an interface 8 at which the chamber is fluidly connected to one or more conduits 7 within the body 3 for conveying coolant fluid from the mouth 3g to the holes 3h. The ribs 3e can be positioned so that each of the sectors has a similar shape and size so that each sector 5a has a similar or same shape or size. Alternatively, the ribs 3e can be positioned so that different sectors 5a have different shapes or sizes (e.g. make up different sized portions of the empty space of the chamber 5).

The chamber 5 and mouth 3g that is in fluid communication with the chamber 5 at the second end 3d of the body 3 can be components of the coolant fluid passageway system 9 defined in the body 3. The body 3 can have one or more conduits 7 that are defined within the body 3 to extend from the chamber 5. Each conduit can have a first end in fluid communication with a respective hole 3h defined in the outer surface 3a of the body 3 and a second end that is in fluid communication with the chamber 5. The conduit(s) 7 can be components of the coolant fluid passageway system 9. The holes 3h can also be considered elements of the coolant fluid passageway system.

At least one of the conduits 7 can have an interface 8 with the chamber 5 within the intermediate portion 3b of the body between the first end 3c and the second end 3d of the body. Coolant fluid within the chamber 5 can be passable into the one or more conduits 7 at the interface so that the coolant fluid is passable through the conduit(s) to the holes 3h for being emitted out of the holes 3h and onto the outer surface. In embodiments that may have multiple conduits 7, different conduits can extend from at least one feed conduit 7 that is positioned between the interface 8 with the chamber 5 and conduits 7 that extend from a respective hole 3h to the feed conduit. In other embodiments, a single conduit 7 can be defined to have numerous branches that can extend from the interface to different holes 3h to supply coolant fluid from the interface 8 to the different holes 3h.

The holes 3h can be circular in shape, oval in shape, or have another type of shape (e.g. hexagonal, rectangular, pentagonal, octagonal, etc.). The holes 3h can be sized and configured to emit coolant at a pre-selected region of the outer surface 3a and/or at a pre-selected velocity or pre-selected velocity range. The holes 3h can be the same size or be different sizes. For example, holes closer to the distal edge of the first end can be smaller or larger than one or more holes 3h that are closer to the intermediate portion 3b of the body. The holes can also have different orientations or shapes to facilitate the direction of the coolant fluid onto different portions of the outer surface 3a of the tool. In some embodiments, the holes 3h can be arranged and positioned to direct the coolant fluid for directing sprays or jets of the coolant fluid out of the conduit(s) 7 and onto the hotter edges of the curved fluted portions of the first end 3c of the body 3.

In some embodiments, the conduit(s) 7 can be defined to provide a smooth passage for the coolant fluid to help minimize any flow resistance the fluid may experience as it passes from the chamber 5 to the holes 3h via the conduit(s) 7. For example, none of the conduits 7 can have any sharp edges or sharp angular turns that may provide significant resistance to the flow of coolant fluid, for example. A sharp turn can be sharp angular turn that can have a projecting edge that can cause turbulence as fluid passes into the sharp angular turn. A sharp edge can be a portion of a conduit that may come to a point that juts into the passageway of the conduit adjacent to a turn or bend of the passageway of the conduit. In contrast to such sharp angular turns having one or more sharp edges, the at least one conduit 7 can be formed in the body to avoid having any such sharp edges and also avoid having any sharp turns. The conduit(s) 7 can be formed to have smooth continuously curved bends, or smooth radial transitions, without any sharp edges, for example. Drilling for forming any conduit 7 may be avoided to help avoid formation of any sharp edge to form the conduit(s) 7, for instance.

The avoidance of a sharp, angular turn can permit a smooth, curved transition for the passage of fluid through the body 3 and out of the hole(s) 3h. In some embodiments, the conduit(s) 7 can be defined so that the conduit(s) 7 extends from the chamber 5 to the hole(s) 3h without having a bend or turn that is greater than 60°. In such embodiments, any such bend or turns of the conduit(s) for the passage of the fluid can be a continuous, curved bend or turn that avoids sharp angular turns and also avoid sharp edges so that there are smooth transitions in flow direction for the fluid as the fluid passes from the chamber 5 to the hole(s) 3h.

The internal portion of the body 3 that defines the conduit(s) 7 can be smooth as well such that the conduit(s) 7 are smooth. The smooth surface can help reduce the friction, or resistance, to the flow of fluid as well.

The body 3 can be shaped and formed to define the coolant fluid passageway system 9 so that the body can retain and facilitate a flow of coolant fluid through the body 3 and out of holes 3h. The coolant fluid can be a liquid in some embodiments. For example, the coolant fluid can be comprised of oil, cutting oil, a synthetic cutting oil, a synthetic oil, or be another type of suitable oil or other suitable type of coolant liquid.

We have surprisingly found that the utilization of a chamber 5 that can be in the second end 3d and/or extend from the second end 3d to the intermediate portion 3b of the body 3 can be sized to be a substantial portion of the width or diameter of the body 3 such that a major portion of the second end 3d and the intermediate portion 3b of the body 3 is empty space of the chamber 5. In some embodiments, the chamber 5 can be sized so that over 20% of the volume of the second end 3d of the body is void of metal and is empty space of the chamber 5, for example. In some embodiments, the second end 3d and the intermediate portion of the body 3b that can define an inner end of the chamber 5 that is opposite the mouth 3g and at the interface 8 with the conduit(s) 7 can be shaped so that the chamber 5 is sized so that over 20% of the volume of the body between the interface 8 and the mouth 3g is empty space (e.g. void of structure). For example, between 20% and 40% of this portion of the body (e.g. from the interface 8 of the intermediate portion 3b of the body and the mouth 3g of the second end 3d) can be void of structure to provide more internal volume for the coolant fluid. As another example, between 20% and 30% of this portion of the body (e.g. from the interface 8 of the intermediate portion 3b of the body and the mouth 3g of the second end 3d) can be void of structure to provide more internal volume for the coolant fluid. This type of sizing of the chamber 5 can also help significantly reduce the mass, or weight, of the body 3.

This type of internal structure of the body 3 can provide a large volume of space for receipt of more coolant fluid to providing cooling to the body 3 when the cutting tool is in use. This can also provide a greater supply of cooling fluid to the conduit(s) 7 for providing more coolant fluid at a greater velocity or flow rate to the holes 3h, which can provide enhanced cooling as well as provide a greater flow of coolant fluid onto the outer surface 3a of the body for removal of debris (e.g. cutting chips).

Further, such a large chamber 5 configuration was surprisingly found to still provide sufficient strength and stiffness to support industrial use of the tool 1 during cutting of workpieces. Conventionally, a heavy, solid mass of metal was typically used to help provide sufficient strength and stiffness so a cutting tool could withstand forces that are imparted when the cutting tool manipulates a workpiece. However, we surprisingly found that a substantially lightweight structure can be utilized instead to provide increased cooling and debris removal functionality without loss of strength and durability of the body 3 for industrial applications. This was a surprising and unexpected result that is contrary to conventional approaches. Moreover, it facilitated a lighter weight cutting tool 1 that can require use of substantially less material compared to conventional designs, which can provide an improved environmental effect for making of such tools as well as significantly reducing the cost of such tools. For example, in some embodiments, the body 3 of the tool can be formed to have 20%-40% less material as compared to conventional designs of similarly sized tools.

We have surprisingly found that embodiments can provide a reduced capital cost associated with the tool 1 while also reducing the environmental impact associated with making the tool 1 and improved efficiency in use of the tool via providing higher velocity jets of coolant fluid out of holes 3h for debris removal and enhanced cooling that can reduce wear and improve the life of the cutting tool.

The recesses 3r can be defined in the first end 3c of the body 3 to facilitate positioning and attachment of cutting elements 6 within or on those recesses 3r. The cutting elements 6 can be cutting elements 6 that are brazed onto the outer surface 3a in those recesses 3r, for example, so that the cutting elements 6 are attached to the body such that they are integral with the body 3. The recesses 3r can be indentations, grooves, or other type of recess structure defined on the outer surface 3a for locating and/or retention of one or more cutting elements 6. The cutting elements 6 can be comprised of a material that is harder than the material of the body 3. For example, the cutting elements 6 can be comprised of PCD and the body 3 can be comprised of steel, cemented carbide, a carbide material, tungsten carbide, cemented tungsten carbide, or other suitable material.

The body 3 can be defined to include the coolant fluid passageway system 9 having the mouth 3g, chamber 5 with chamber sectors 5a, interface 8, conduit(s) 7 and holes 3h via an additive manufacturing processing. Such processing can permit the coolant fluid passageway system 9 to provide a smooth surfaced passageway for flow of the coolant fluid through the body 3 that avoid sharp edges or sharp bends that can conventionally be present due to the use of drilling or EDM processing of a cutting tool. We have surprisingly found that utilization of such an additive manufacturing process can also help permit formation of the body 3 so that less material is used in the fabrication of the body 3 and a lighter weight body having a larger volume of space for coolant fluid can be provided as discussed above. The additive manufacturing processing that may be utilized can include powder bed fusion, laser deposition, or binder jet processing. In embodiments that may use binder jet processing, the body that is formed via the process may be heated for a pre-selected curing time period to cure the formed body 3. Thereafter, one or more cutting elements 6 can be attached to the body via the recesses 9 (e.g. via brazing or other suitable attachment process).

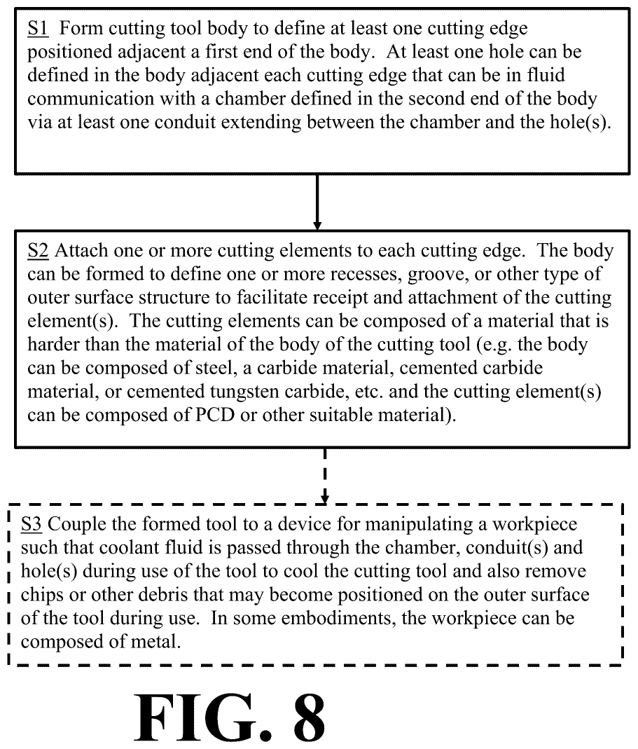

FIG. 8 illustrates an exemplary process for making and/or using an embodiment of the cutting tool 1. In a first step S1, the cutting tool body 3 can be formed to define at least one cutting edge positioned adjacent a first end 3c of the body 3. At least one hole 3h can be defined in the body 3 adjacent each cutting edge that can be in fluid communication with a chamber 5 defined in the second end 3d of the body 3 via at least one conduit 7 extending between the chamber 5 and the hole(s) 3h. The formation of the body 3 can be via an additive manufacturing process. In some embodiments that may utilize a binder (e.g. in a binder jet process), the formed body can be subject to heat for a pre-selected curing time at a pre-selected curing temperature to cure the formed body 3. In other embodiments that may utilize a laser or other type of additive manufacturing process, the body may not need to undergo curing after it is formed.

In a second step S2, one or more cutting elements 6 can be attached to each cutting edge. Recesses 3r can be defined in the outer surface 3a of the body to locate the positioning for each cutting element 6. The body 3 can be formed to define one or more recesses (e.g. at least one groove, indent, or other type of outer surface structure) to facilitate receipt and attachment of the cutting element(s). The cutting elements 6 can be composed of a material that is harder than the material of the body 3 of the cutting tool 1 (e.g. the body 3 can be composed of steel, a carbide material, cemented carbide material, or cemented tungsten carbide, etc. and the cutting element(s) 6 can be composed of PCD or other suitable material).

The first and second steps S1 and S2 can be utilized to make an embodiment of the cutting tool. A third step S3 can be included for the use of the cutting tool 1. In the third step S3 (shown in broken line), the formed tool 1 can be coupled to a device for manipulating a workpiece such that coolant fluid is passed through the coolant fluid passageway system 9 (e.g. the mouth 3g, chamber 5 with chamber sectors 5a, interface 8, conduit(s) 7 and holes 3h) during use of the tool 1 to cool the cutting tool 1 and also remove chips or other debris that may become positioned on the outer surface 3a of the tool 1 during use. In some embodiments, the workpiece can be composed of metal.

Embodiments of the process can also include other steps. For example, the cutting tool 1 may undergo cleaning, polishing, or other treatments as part of the fabrication process for forming the cutting tool 1. In conjunction with use of the formed cutting tool, the process can also include other steps in addition to the third step S3, such as providing coolant fluid and/or supplying coolant fluid to the cutting tool 1.

As discussed above, we have surprisingly found that embodiments can provide a reduced capital cost associated with the cutting tool 1 while also reducing the environmental impact associated with making the tool 1 and improved efficiency in use of the tool via providing higher velocity jets of coolant fluid out of holes 3h for debris removal and enhanced cooling that can reduce wear and improve the life of the cutting tool. This was unexpected to us because the approach utilized for such improvements resulted in permitting a significant reduction in the mass of the formed cutting tool 1. This is particularly surprising for embodiments of the cutting tool 1 that are structured and configured as a reamer or a tool configured to form an aperture or hole in a workpiece or enlarge an aperture or hole in a workpiece.

It should be appreciated that the exemplary embodiments discussed herein can be adjusted to account for a particular set of design criteria. For example, the size and shape of the body, the size and shape of cutting elements 6, the size and shape of fluid conduit segments, mouth 3g, chamber 5, or holes 3h, and the type of materials utilized for the cutting tool 1 can be any of a number of different options. For instance, the type of material used for the body 3 (e.g. carbide, cemented carbine, tungsten carbide, steel, etc.) of the cutting tool 1 and the type of material used for the cutting elements 6 (e.g. a carbide material, PCD, tungsten carbide, etc.) can be any of a number of suitable material (e.g. cubic boron nitride, ceramic material, other type of hard material, etc.). As another example, the shape of the body 3, flute(s) 3f, recesses 3r, holes 3h, conduits 7, chamber 5, second end 3d, ribs 3e, or cutting elements 6 can be adapted to meet a particular set of design criteria. Thus, while certain present preferred embodiments of the cutting tool and embodiments of methods for making and using the same have been shown and described above, it is to be distinctly understood that the invention is not limited thereto but may be otherwise variously embodied and practiced within the scope of the following claims.

What is claimed is:

1. A cutting tool comprising:
a body having an outer surface, a first end and a second end;
a portion of the outer surface adjacent the first end having one or more recesses defined therein to receive one or more cutting elements, at least one hole being defined in the outer surface adjacent the one or more recesses;
the second end having a chamber defined therein to receive a coolant fluid, the second end also having a mouth in fluid communication with the chamber;
the body having at least one conduit defined therein to fluidly connect the chamber to the at least one hole so that coolant fluid fed into the chamber is passable to the at least one hole for being emitted onto the outer surface via the at least one hole.

2. The cutting tool of claim 1, wherein the at least one hole includes a plurality of spaced apart holes.

3. The cutting tool of claim 2, wherein the body has a plurality of ribs positioned in the chamber to divide the chamber into sectors.

4. The cutting tool of claim 3, wherein each of the ribs have a same shape and size.

5. The cutting tool of claim 1, wherein the at least one conduit extends from the chamber to the at least one hole without any sharp edges or any sharp turns.

6. The cutting tool of claim 5, wherein a sharp turn is a bend of the conduit that is greater than 60

7. The cutting tool of claim 5, wherein the body is formed via an additive manufacturing process to define the mouth, the chamber, the at least one conduit, and the at least one hole.

8. The cutting tool of claim 7, wherein the additive manufacturing process is a binder jet process.

9. The cutting tool of claim 1, wherein the body is comprised of cemented carbide, cemented tungsten carbide, carbide material, or steel.

10. The cutting tool of claim 1, comprising the one or more cutting elements, each of the cutting elements comprised of a material that is harder than a material of the body.

11. The cutting tool of claim 1, wherein the one or more cutting elements are attached to the body via the one or more recesses such that each cutting element is integral with the body.

12. The cutting tool of claim 1, wherein the chamber extends from the second end to an intermediate portion of the body between the first end and the second end, the chamber having an interface with the at least one conduit that is opposite the mouth of the body, the chamber being defined in the body such that at least 20% of a volume of the body between the interface and the mouth is empty space for receipt of the coolant fluid.

13. The cutting tool of claim 1, wherein a hub is positioned within the chamber and a plurality of ribs extend from the hub to an inner wall of the body defining the chamber to define different sectors of the chamber.

14. A process of making and/or using a cutting tool, the process comprising:
forming a body of a cutting tool such that the body includes:
an outer surface, a first end and a second end;
a portion of the outer surface adjacent the first end having one or more recesses defined therein to receive one or more cutting elements, at least one hole being defined in the outer surface adjacent the one or more recesses;
the second end having a chamber defined therein to receive a coolant fluid, the second end also having a mouth in fluid communication with the chamber;
the body being formed such that the body has at least one conduit defined therein to fluidly connect the chamber to the at least one hole so that coolant fluid fed into the chamber is passable to the at least one hole for being emitted onto the outer surface via the at least one hole;
attaching one or more cutting elements to the outer surface of the body via the one or more recesses such that each cutting element is integral to the body.

15. The process of claim 14, wherein the one or more cutting elements are attached to the body via brazing and the one or more recesses are defined in at least one cutting edge of the body.

16. The process of claim 14, wherein the body is formed via an additive manufacturing process.

17. The process of claim 14, wherein the body is formed via a binder jet process.

18. The process of claim 14, wherein the body is comprised of cemented carbide, cemented tungsten carbide, carbide material, or steel.

19. The process of claim 14, wherein the body is formed such that the chamber extends from the second end to an intermediate portion of the body between the first end and the second end, the chamber having an interface with the at least one conduit that is opposite the mouth of the body, the chamber being defined in the body such that at least 20% of a volume of the body between the interface and the mouth is empty space for receipt of the coolant fluid.

20. The process of claim 14, wherein the body is formed such that the at least one conduit extends from the chamber to the at least one hole without having an angular turn that is greater than 60°.
